(19) United States
(12) Patent Application Publication
(10) Pub. No.: US 2019/0041978 A1
(43) Pub. Date: Feb. 7, 2019

(54) USER DEFINED HEAD GESTURES METHODS AND APPARATUS

(71) Applicant: Intel Corporation, Santa Clara, CA (US)

(72) Inventors: Darrell Loh, Burnaby (CA); Glenn Dyck, Vancouver (CA); Aubrey Shick, Berkeley, CA (US); Etienne Naugle, New Westminster (CA)

(21) Appl. No.: 15/666,505

(22) Filed: Aug. 1, 2017

(51) Int. Cl. G06F 3/01; G06F 3/0346; G06F 1/16

(52) U.S. Cl. CPC G06F 3/012; G06F 1/163; G06F 3/011; G06F 3/0346

(57) ABSTRACT

Embodiments include apparatuses, methods, and a computer system including a calibrator that may calibrate sensor data of a plurality of sensors of a head worn wearable adorn on a head of a user. The calibrator may calibrate sensor data for one or more notifications or events to generate calibrated sensor data that reflects physical attributes, positions or postures of the user. The calibrated sensor data may be used to determine an orientation or movement of the head of the user, which may further be used to detect a head gesture defined by the user that corresponds to a computer command. Other embodiments may be described and/or claimed.

### FIELD

Embodiments of the present invention relate generally to the technical field of computing, and more particularly to methods and apparatuses related to detection of user defined head gestures that involves subtle head movements, including their applications to controlling various devices, e.g., a user interface of a computer device.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

A computer device, or simply a computer, may be a device that can be instructed to carry out an arbitrary set of arithmetic or logical operations automatically. The ability of a computer device to follow generalized sequences of operations enables it to perform a wide range of tasks. A user interface (UI) may often refer to human-computer interactions. A goal of the human-computer interactions is to allow effective operation and control of the computer device from a user. Smart UI devices may include wearable devices, such as smart eyewear, head-worn wearable devices, which may be simply referred to as head-worn wearables, or eye-tracking devices. For example, when head-worn wearables are used as UI devices, a user may use head movement, such as nods and shakes, to control a computer device through the head-worn wearables. However, current smart UI devices may have user interaction problems. Typically, when head-worn wearables are used, large head gestures, such as nods and shakes, which may be perceivable in public by other humans are required, which may be problematic for user personal comfort, social acceptance and causing more fatigue to the users. Similarly, eye-tracking devices may be uncomfortable or inapplicable in some scenarios. Furthermore, smart UI devices, such as smart eyewear, head-worn wearables, or eye-tracking devices, may be physically large, and hence uncomfortable to wear by a user, in addition to being high power consuming.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example system including a head worn wearable adorned on a head of a user, and a computer device coupled to the head worn wearable to perform a control based on a head gesture defined by the user, in accordance with various embodiments.

FIG. 2 illustrates an example process for a computer device to perform a control based on a head gesture defined by a user, in accordance with various embodiments.

FIG. 3 illustrates an example flow diagram for a computer system to perform a control based on a head gesture defined by a user, in accordance with various embodiments.

FIG. 4 illustrates an example process for a computer device to determine a head gesture defined by a user, in accordance with various embodiments.

FIG. 5 illustrates another example process for a computer device to determine a head gesture defined by a user, in accordance with various embodiments.

FIG. 6 illustrates exemplary head gestures defined by a user, in accordance with various embodiments.

FIG. 7 illustrates an example computer device suitable for use to practice various aspects of the present disclosure, in accordance with various embodiments.

FIG. 8 illustrates a storage medium having instructions for practicing methods described with references to FIGS. 1-7, in accordance with various embodiments.

### DETAILED DESCRIPTION

Apparatuses, methods, and storage medium are disclosed herewith related to user interface (UI) based on head gestures defined by a user to control a computer device. Head gestures defined by a user may be subtle head motions or gestures conducted by a user of the computer device. Subtle head gestures defined by a user may be preferable over the standard head gestures, such as nods and shakes, in terms of usability, user comfort, and reduced social cost. Control based on subtle head gestures defined by a user may improve upon hand based control, such as touch pads (optical or capacitive), by keeping the hands free to perform other tasks. Data about a user's head position or movement associated with a subtle head gesture may be generated or collected by low power devices, such as microelectromechanical systems (MEMS), head worn wearables, or inertial measurement units (IMU), which may have reduced power consumption as compared to camera or depth sensor interaction used in other smart UIs. The MEMS devices, head worn wearables, or IMUS may also have smaller physical forms compared to other normal head-worn UI devices.

Subtle head gestures defined by a user may be determined based on sensor data output by a plurality of sensors of a head worn wearable adorned on a head of a user. Sensor data collected or generated by a plurality of sensors, e.g., accelerometers, gyroscopes, or magnetometers, may be fused through a sensor fusion module to increase the quality of the sensor data to generate fused sensor data. Furthermore, a calibrator may dynamically calibrate the sensor data of the plurality of sensors of the head worn wearable for one or more notifications or events to generate calibrated sensor data that reflects physical attributes, positions or postures of the user, thus allowing the user defined head gestures to be subtle, involving small amount of head movements. A subtle head gesture defined by the user may be identified based on the calibrated sensor data, which may dynamically adjust the determination of the subtle head gesture defined by the user based on the user's preference, positions, or other body movement, in addition to other environment parameters such as the time of the day, or the application the computer device is for. A subtle head gesture may be simply referred to as a head gesture.

In embodiments, a computer device may include a receiver and a calibrator coupled to the receiver. The receiver may receive sensor data output by a plurality of sensors of a head worn wearable adorned on a head of a user. The calibrator may calibrate the sensor data of the plurality of sensors of the head worn wearable for one or more notifications or events to generate calibrated sensor data that reflects physical attributes, positions or postures of the user. The calibrated sensor data may be used to determine an orientation or movement of the head of the user, which may further be used to detect a head gesture defined by the user that corresponds to a computer command.

In embodiments, a method for controlling a computer device with a head worn wearable may include: receiving sensor data output by a plurality of sensors of the head worn wearable while the head worn wearable is adorn on a head of a user; calibrating the sensor data of the plurality of sensors of the head worn wearable for one or more notifications or events to generate calibrated sensor data that reflects physical attributes, positions or postures of the user; determining a head gesture defined by the user based on the calibrated sensor data; identifying a computer command corresponding to the head gesture defined by the user; and performing a control based on the computer command.

In embodiments, one or more non-transitory computer-readable media may include instructions to operate a computer device to receive sensor data output by a plurality of sensors of a head worn wearable while the head worn wearable is adorn on a head of a user; calibrate the sensor data of the plurality of sensors of the head worn wearable for one or more notifications or events to generate calibrated sensor data that reflects physical attributes, positions or postures of the user; determine a head gesture defined by the user based on the calibrated sensor data; identify a computer command corresponding to the head gesture defined by the user; and perform a control based on the computer command.

In the description to follow, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Operations of various methods may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiments. Various additional operations may be performed and/or described operations may be omitted, split or combined in additional embodiments.

For the purposes of the present disclosure, the phrase “A or B” and “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used hereinafter, including the claims, the term “module” or “routine” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

The terms “coupled with” and “coupled to” and the like may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. By way of example and not limitation, “coupled” may mean two or more elements or devices are coupled by electrical connections on a printed circuit board such as a motherboard, for example. By way of example and not limitation, “coupled” may mean two or more elements/devices cooperate and/or interact through one or more network linkages such as wired and/or wireless networks. By way of example and not limitation, a computing apparatus may include two or more computing devices “coupled” on a motherboard or by one or more network linkages.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. As used herein, “computer-implemented method” may refer to any method executed by one or more processors, a computer system having one or more processors, a mobile device such as a smartphone (which may include one or more processors), a tablet, a laptop computer, a set-top box, a gaming console, and so forth.

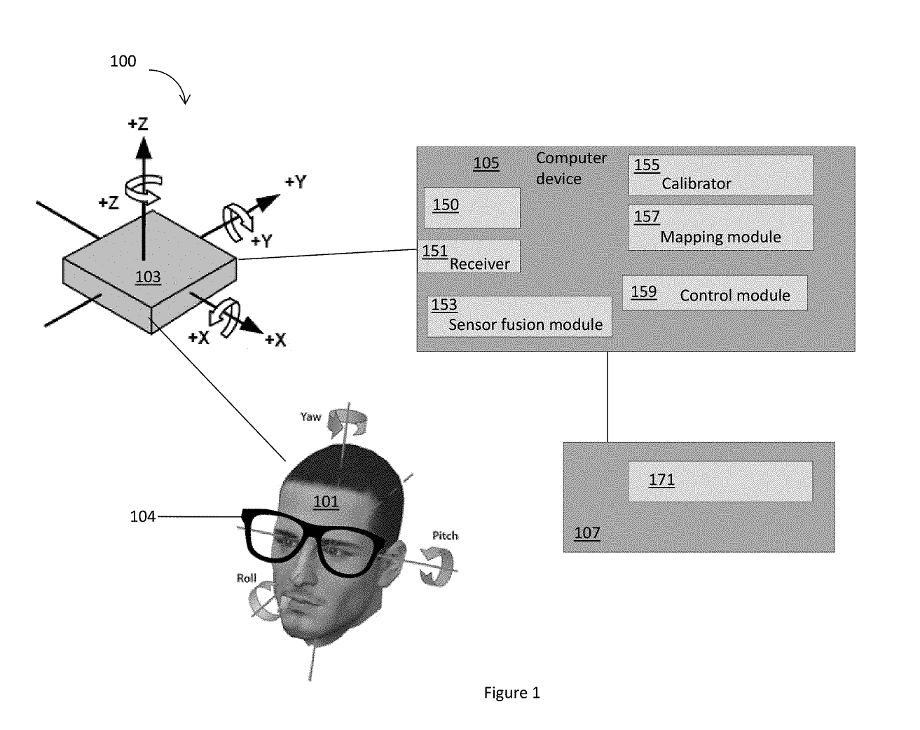

FIG. 1 illustrates an example system 100 including a head worn wearable 104 (an inertial measurement unit (IMU) 103) to be adorned on a head of a user 101, and a computer device 105 communicatively coupled to the head worn wearable 104 to allow a control based of computer device 105 to be based on a subtle head gesture defined by the user 101, in accordance with various embodiments. For clarity, features of the system 100 may be described below as an example for understanding an example computer device 105 that may be complemented by a head worn wearable 104 communicatively coupled to control the computer device 105 based on a subtle head gesture (hereinafter, simple head gesture) defined by a user. It is to be understood that there may be more or fewer components included in the system 100. Further, it is to be understood that one or more of the devices and components within the system 100 may include additional and/or varying features from the description below, and may include any device that one having ordinary skill in the art would consider and/or refer to as the devices and components of system 100.

In embodiments, the system 100 may include the head worn wearable 104 and the computer device 105, where the head worn wearable 104 may be adorned on a head of the user 101. In addition, the system 100 may include other components, e.g., a display device 107. The computer device 105 may include a processor 150 and a receiver 151. In addition, the computer device 105 may include a sensor fusion module 153, a calibrator 155, a mapping module 157, and a control module 159, which may be executed on the processor 150. In embodiments, processor 150 may include a hardware accelerator (such as a Field Programmable Array (FPGA)). In some of these embodiments, some functions or the entirety of sensor fusion module 153, calibrator 155, mapping module 157, and control module 159 may be implemented with the hardware accelerator.

The receiver 151 may receive sensor data output by a plurality of sensors of the head worn wearable 104. The calibrator 155 may calibrate the sensor data of the plurality of sensors of the head worn wearable 104 for one or more notifications or events to generate calibrated sensor data that reflects physical attributes, positions or postures of the user 101. The mapping module 157 may determine a head gesture defined by the user 101 based on the calibrated sensor data, and may identify a computer command corresponding to the head gesture defined by the user 101. The control module 159 may perform a control based on the computer command identified by the mapping module 157. The dynamic calibration enables the user defined head gesture to be subtle, which may provide increase comfort, and therefore improved usability for the user. In embodiments, except for the teachings of the present disclosure to enable detection and discernment of subtle user defined head gestures, the head worn wearable 104, the computer device 105, the processor 150, the display device 107 may be any head worn wearable, computer device, processor, and display device may be any such elements one having ordinary skill in the art would consider and/or refer to as an head worn wearable, a computer device, a processor, and a display device, respectively.

In embodiments, the user 101 may be of any physical attributes such as height, in any positions, postures, culture background, or other characteristics. The user 101 may be in a standing position, a sitting position, a lying position, or other positions. The user position, an orientation or movement of the head of the user, may be detected by the sensors within the head worn wearable 104 or other sensors or devices. In response to the user positions or movements, the calibrator 155 may dynamically calibrate the sensor data of the plurality of sensors of the head worn wearable 103 for one or more notifications or events to generate calibrated sensor data that reflects physical attributes, positions or postures of the user 101. The user 101 may move the head in any of the orientations, e.g., roll, pitch, or yaw. The head movements around the orientations may be determined to be a head gesture defined by a user by the mapping module 157, which may be used to control the computer device 105 or other devices.

In embodiments, the head worn wearable 104 may be an electronic device that measures and reports data associated with the head position, orientation, or movement of the user 101. The head worn wearable 104 may include a plurality of sensors of different sensor types. For example, the head worn wearable 104 may include the IMU 103 that includes sensors, such as an accelerometer, a gyroscope, or a magnetometer. The IMU 103 may measure and report such as acceleration, angular rate, and sometimes the magnetic field surrounding the body, using an accelerometer, a gyroscope, or a magnetometer. Data generated or collected by the IMU 103 may include data for 3-axis gyroscope, data for 3-axis accelerometer, and data for 3-axis magnetometer, which may form 9 axes of head movement data. For example, the data generated by the IMU 103 may include roll rotation data for the user's head, pitch rotation data for the user's head, or yaw rotation data for the user's head. In some embodiments, roll rotation data, pitch rotation data, and yaw rotation data may be obtained by a gyroscope alone. An accelerometer may measure acceleration. Sometimes, an accelerometer may be used to measure tilt from vertical, roll and pitch. An accelerometer with a magnetometer may be used as a 3D electronic compass for accurate direction detection. In some embodiments, an accelerometer and a gyroscope may be used together for roll rotation data and pitch rotation data, while a gyroscope and a magnetometer may be used together for yaw rotation data. An accelerometer, a magnetometer, and a gyroscope may allow tracking of orientation, gravity, and linear acceleration.

In some embodiments, the sensor data generated or collected by the IMU 103 may include: absolute orientation, such as three axis orientation data based on a 360° sphere, or four point quaternion output for more accurate data manipulation; angular velocity vector, such as three axis of rotation speed; acceleration vector, such as three axis of acceleration (gravity+linear motion); linear acceleration vector, such as three axis of linear acceleration data (acceleration minus gravity). In addition, the sensor data generated or collected by the IMU 103 may include magnetic field strength, such as three axis of magnetic field; gravity vector, such as three axis of gravitational acceleration; ambient temperature, or other data related to the user 101 or the surrounding environment. In some embodiments, the IMU 103 may be able to detect head movements of small degrees, such as 0.1 degree, or 0.001 degree.

In embodiments, the head worn wearable 104 may be a wireless head worn wearable. Sensor data collected by the head worn wearable 104 may be sent to the computer device 105 which in these embodiments are external to the head worn wearable 104, so that the computer device 105 may perform various computation/processing operations on the sensor data outside the head worn wearable 104. For these embodiments, head worn wearable 104 may have much less computational power as compared to current conventional head worn wearables. Resultantly, the head worn wearable 104 may also be much smaller than current convention head-worn wearable devices. For example, in some embodiments the head worn wearable 104 may have a dimension around 25 mm×20 mm×10 mm. On the other hand, a conventional head worn device, such as Google™ Glass, may be much larger, such as 5.25 inches wide and 8 inch long, which may be equivalent to 203 mm×127 mm. Furthermore, conventional head-worn wearable devices may often be designed for various targeted applications. For example, a conventional head-worn wearable device for entertainment may be different from a conventional head-worn wearable device for medical application. On the other hand, the head worn wearable 104 may substantially include only the sensors, and the sensor data generated by the head worn wearable 104 may be used in any kind of application running on the computer device 105 or other computing devices communicatively coupled with computer device 105. The separation of the sensors in the head worn wearable 104 and the computer device 105 may provide much more flexibility for the user 101 so that the user 101 does not have to wear the computer device 105 on the head. However, in some embodiments, the teaching of the present disclosure may nonetheless be practiced with the head worn wearable 103 having the computer device 105 integrated therein.

In embodiments, the computer device 105 may include the calibrator 155. The calibrator 155 may dynamically calibrate the sensor data of the sensors of the head worn wearable 104 for one or more notifications or events to generate calibrated sensor data that reflects physical attributes, positions or postures of the user. For example, the user 101 may be in a standing position, a sitting position, or a lying position. The one or more notifications or events may include a change from a first position to a second position by the user 101, wherein the first position may be a position selected from a standing position, a sitting position, or a lying position, and the second position may be different from the first position and may be a position selected from a standing position, a sitting position, or a lying position. For a position the user 101 may be in, the calibrator 155 may provide the calibrated sensor data associated with the position to the mapping module 157 to determine a head gesture defined by the user 101. For example, when the user 101 is in a lying position, the head may have a movement of larger degree to indicate a head gesture defined by a user, compared to the situation when the user 101 may be in a standing position. In addition, the user 101 may change from a first position to a second position, and the sensors in the head worn wearable 104 may generate sensor data that can be used to detect the position change as well. Based on the position change data, the calibrator 155 may dynamically recalibrate the sensor data prior to making further determination of a head gesture defined by a user for the position. In addition, the calibrator 155 may calibrate the sensor data of the sensors of the head worn wearable 104 depending on a user physical attributes, preferences, or profiles. For example, a user may have ears at different heights, the head may be naturally tilted one way or the other, etc., the calibrator 155 may calibrate the sensor data of the sensors of the head worn wearable 103 taking into consideration of the height of the ear, or the natural position of the head of the user 101. For a different user, the calibrator 155 may make different inferences due to the user's differences in physical attributes, positions or postures.

In embodiments, the computer device 105 may include the sensor fusion module 153. The sensor fusion module 153 may apply a sensor data fusion algorithm to the sensor data received from different types of sensors within the head worn wearable 103 to generate fused sensor data, which may be used by the mapping module 157 to determine a head gesture defined by the user 101. Similarly, the calibrator 155 may generate the calibrated sensor data based on the fused sensor data from the sensor fusion module 153. In embodiments, the sensor fusion module 153 may intelligently combine sensor data from several different types of sensors in the head worn wearable 104 to improve the quality or accuracy of the data. For example, the sensor fusion module 153 may correct any deficiencies of the individual sensors in the head worn wearable 104 to calculate accurate position and orientation information. In embodiments, the sensor fusion module 153 may perform various sensor data fusion algorithms and methods, such as, but not limited to, central limit theorem, Kalman filter, Bayesian networks, or Dempster-Shafer method to improve the quality of the data generated by the sensors in the head worn wearable 103. The sensor fusion module 153 may perform sensor data fusion at different categories or levels, such as data alignment, entity assessment, tracking and object detection, recognition, identification, situation assessment, impact assessment, process refinement, or user refinement.

In embodiments, the computer device 105 may include the mapping module 157, which may determine a head gesture defined by a user based on the calibrated sensor data generated by the calibrator 155. A head gesture defined by a user may be different from the normal socially recognizable head movements, such as nods or shakes. Instead, a head gesture defined by a user may be predefined, and may be smaller or more subtle than the normal head movements. For example, a head gesture defined by a user may not be perceivable by other human and hence not considered socially awkward, but can be detected by the head worn wearable 103 or other devices.

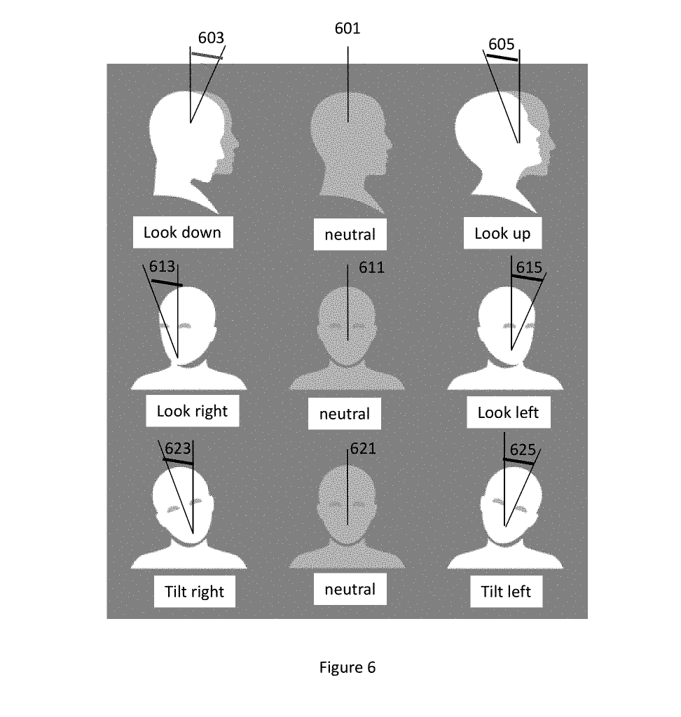

In some embodiments, a head gesture defined by a user may be one selected from the following: a gesture of look up by a degree less than a first predetermined degree, a gesture of look down by a degree less than a second predetermined degree, a gesture of look right by a degree less than a third predetermined degree, a gesture of look left by a degree less than a fourth predetermined degree, a gesture of tilt right by a degree less than a fifth predetermined degree, a gesture of tilt left by a degree less than a sixth predetermined degree, or a gesture of steady movement of the user's head. In embodiments, the first predetermined degree, the second predetermined degree, the third predetermined degree, the fourth predetermined degree, the fifth predetermined degree, or the sixth predetermined degree may be less than 10 degree. The user 101 or the calibrator 155 may determine what degree the head gesture defined by the user 101 may be. For example, the first predetermined degree, the second predetermined degree, the third predetermined degree, the fourth predetermined degree, the fifth predetermined degree, or the sixth predetermined degree may be less than 8 degree, 15 degree, or any other degree that may be different (smaller) from the socially recognizable head movements. More illustrations of the head gesture defined by the user 101 may be found in the description of FIG. 6.

In addition to the various gestures created by the head movement in any of the orientations, e.g., roll, pitch, or yaw, the speed of the head movement may be used by the mapping module 157 to determine some head gesture defined by the user 101 or a sequence of head gestures defined by the user 101. For example, the user 101 may move the head in a steady speed up or down, the mapping module 157 may generate a sequence of related gestures, which may be mapped by the mapping module 157 to a sequence of computer command. For example, when the user 101 may be reading a text document, the user 101 may move up the head in a steady speed. Accordingly, the mapping module 157 may generate a sequence of related gestures, and may further generate a sequence of computer commands to steady move up the portion of the text document the user 101 is reading.

In embodiments, the mapping module 157 may further identify a computer command corresponding to a head gesture defined by a user. For example, the mapping module 157 may map a head gesture defined by a user to a command to lock the computer device, a command to unlock the computer device, a command to shut off the computer device, a command to accept an incoming call, or a system command. In some embodiments, when the computer device 105 is coupled to the display device 107, the computer command may be related to an object 171 displayed on the display device 107. Hence, the computer command may be a command to interact with the object displayed on the display device, a command to expand the object displayed, a command to close the object displayed, a command to select the object displayed, or a command to steady move from a first part of the object displayed to a second part of the object displayed.

In embodiments, for example, the mapping module 157 may map a gesture of look up by a degree less than a first predetermined degree to a command to unlock the computer device 105, map a gesture of look down by a degree less than a second predetermined degree to a command to accept an incoming call. The mapping module 157 may map a gesture of tilt right by a degree less than a fifth predetermined degree or a gesture of tilt left by a degree less than a sixth predetermined degree to a command to control a music track being played on the computer device 105. The mapping module 157 may map a gesture of look right by a degree less than a third predetermined degree or a gesture of look left by a degree less than a fourth predetermined degree to a command to rewind or fast forward a movie being played by the computer device 105.

In embodiments, the computer device 105 may include the control module 159, which may be used to control the computer device 105, the display 107, or other devices coupled to the computer device 105, not shown. For example, the control module 159 may control the operations of home security control system, home appliances, a vehicle, or other devices and systems. In some embodiments, the control module 159 may perform a control remotely, e.g., by wireless technology. The control module 159 may perform a control for any command, such as a command to lock the computer device, a command to unlock the computer device, a command to shut off the computer device, a command to accept an incoming call, or a system command. In some embodiments, when the computer device 105 is coupled to the display device 107, the control module 159 may perform a control for a command related to an object displayed on the display device.

In embodiments, the display device 107 may be any display device, such as a light-emitting diode (LED) display, a liquid crystal display (LCD), a thin film transistor liquid crystal display (TFT-LCD), a digital light processing (DLP) display, a plasma display, an electroluminescent panel, an organic light-emitting diode (OLED) display, or an electronic paper. In embodiments, the display device 107 may be mounted on a headset attached to the user 101. In some other embodiments, the display device 107 may be placed away from the user 101.

In embodiments, an object 171 may be displayed on the display device 107. For example, the object 171 displayed on the display device 107 may include a button, a slider, a scroll wheel, a window, an icon, a menu, a pointer, a widget, a shortcut, a notification, a label, a folder, or a toolbar of an user interface. The object 171 displayed on the display device 107 may represent a multimedia display content such as music, movies, photos, videos, or application. The control module 159 may perform a control on a data object that corresponds to the displayed object 171 for a command to interact with the object 171 displayed on the display device, a command to expand the object 171 displayed, a command to close the object 171 displayed, a command to select the object 171 displayed, or a command to steady move from a first part of the object 171 displayed to a second part of the object 171 displayed.

In embodiments, there may be other input device, not shown, coupled to the computer device 105. For example, there may be a pressure sensor, a humidity sensor, a proximity sensor, a position sensor, or a temperature sensor, a keyboard, a cursor control device, a pointing stick, a trackball, a camera, a microphone, a touchscreen, a touchpad, or some other input devices. The head worn wearable 103, the sensor fusion module 153, the calibrator 155, the mapping module 157, the control module 159 may be used in addition to other input devices or control devices.

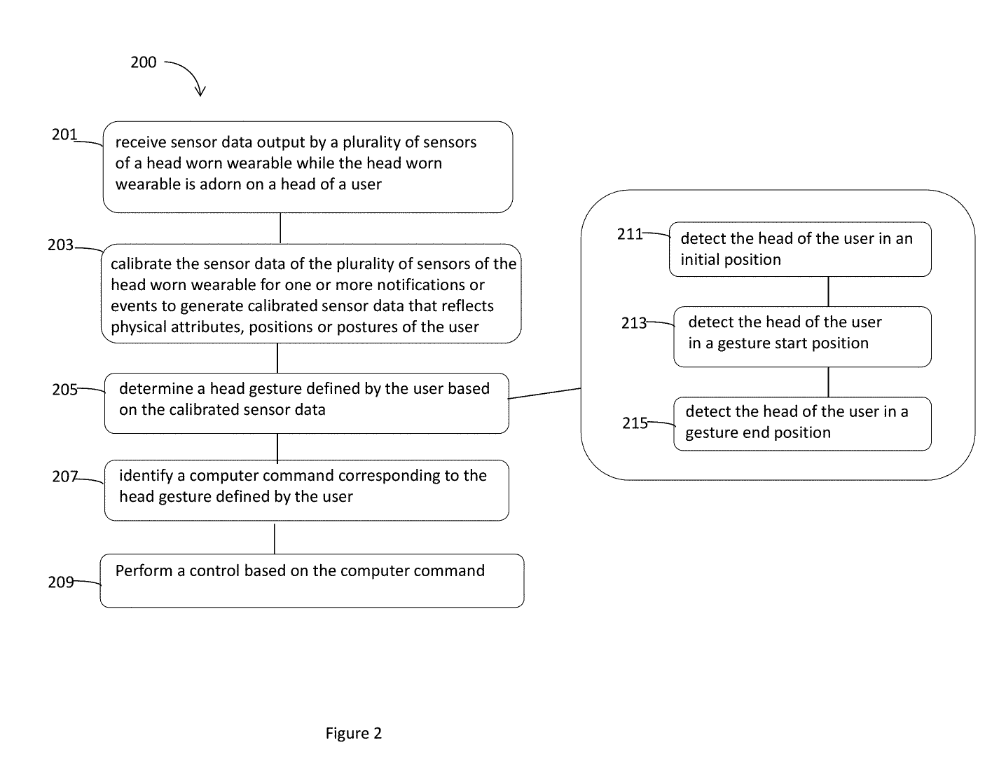

FIG. 2 illustrates an example process 200 for a computer device to perform a control based on a head gesture defined by a user, in accordance with various embodiments. In embodiments, the process 200 may be a process performed by the computer device 105 in FIG. 1, where the interactions of the process 200 may be performed by various modules in the computer device 105, such as the sensor fusion module 153, the calibrator 155, the mapping module 157, or the control module 159.

The process 200 may start at an interaction 201. During the interaction 201, the computer device may receive sensor data output by a plurality of sensors of a head worn wearable while the head worn wearable is adorn on a head of a user. For example, at the interaction 201, the computer device 105 may receive sensor data output by a plurality of sensors of the head worn wearable 103 while the head worn wearable 103 is adorn on a head of the user 101. The sensor data may be generated or collected by the head worn wearable 103, and received by the receiver 151 of the computer device 105.

During an interaction 203, the computer device may dynamically calibrate the sensor data of the plurality of sensors of the head worn wearable for one or more notifications or events to generate calibrated sensor data that reflects physical attributes, positions or postures of the user. For example, at the interaction 203, the calibrator 155 may calibrate the sensor data of the plurality of sensors of the head worn wearable 103 for one or more notifications or events to generate calibrated sensor data. The calibrated sensor data may reflect physical attributes, positions or postures of the user.

During an interaction 205, the computer device may determine a head gesture defined by the user based on the calibrated sensor data. For example, at the interaction 205, the computer device 105 may determine a head gesture defined by the user based on the calibrated sensor data. The determination may be performed by the mapping module 157 of the computer device 105. In some embodiments, the mapping module 157 may determine a head gesture defined by a user by performing a sequence of operations or interactions. For example, during an interaction 211, the mapping module 157 may detect the head of the user in an initial position. During an interaction 213, the mapping module 157 may detect the head of the user in a gesture start position. During an interaction 215, the mapping module 157 may detect the head of the user in a gesture end position. Based on the gesture start position and the gesture end position, the mapping module 157 may determine the head gesture defined by the user.

During an interaction 207, the computer device may identify a computer command corresponding to the head gesture defined by the user. For example, at the interaction 207, the computer device 105 may identify a computer command corresponding to the head gesture defined by the user. The operations may be performed by the mapping module 157 of the computer device 105.

During an interaction 209, the computer device may perform a control based on the computer command. For example, at the interaction 209, the computer device 105 may perform a control based on the computer command determined by the mapping module 157. The control may be performed by the control module 159.

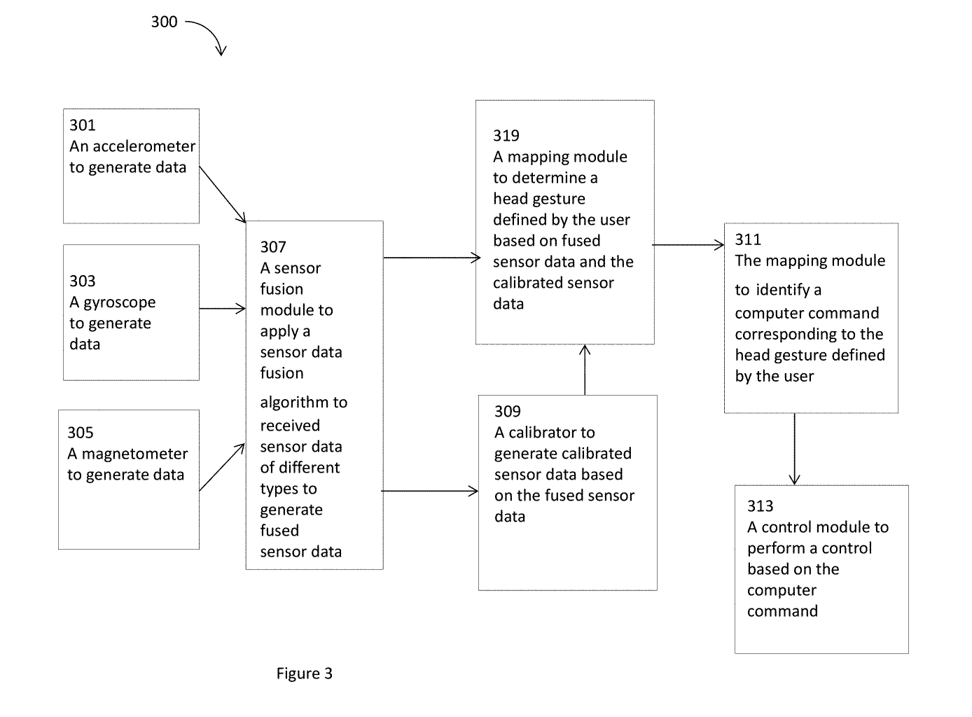

FIG. 3 illustrates an example flow diagram 300 for a computer system to perform a control based on a head gesture defined by a user, in accordance with various embodiments. In embodiments, the flow diagram 300 may be a process performed by the computer system 100 in FIG. 1, where the interactions of the flow diagram 300 may be performed by various modules in the system 100, such as the head worn wearable 103, and the computer device 105 and various components of the computer device 105, such as the sensor fusion module 153, the calibrator 155, the mapping module 157, or the control module 159.

The flow diagram 300 may start an interaction 301, an interaction 303, or an interaction 305. During the interaction 301, an accelerometer may generate data. During the interaction 303, a gyroscope may generate data. During the interaction 305, a magnetometer may generate data. In embodiments, the interaction 301, the interaction 303, and the interaction 305 may be performed independently, or in a coordinated way. The accelerometer, the gyroscope, and the magnetometer may be within the head worn wearable 103. The accelerometer, the gyroscope, and the magnetometer may generate data by periodic sampling, random sampling, or other forms of sampling.

During an interaction 307, a sensor fusion module may apply a sensor data fusion algorithm to received sensor data of different types to generate fused sensor data. In embodiments, the interaction 307 may be performed by the sensor fusion module 153. The sensor data of different types may be received from the accelerometer, the gyroscope, and the magnetometer of the head worn wearable 103. The fused sensor data generated during the interaction 307 may have better accuracy or quality.

During an interaction 309, a calibrator may generate calibrated sensor data based on the fused sensor data. In embodiments, the interaction 309 may be performed by the calibrator 155. The calibrator 155 may perform calibration on the fused sensor data generated by the sensor fusion module.

During an interaction 319, a mapping module may determine a head gesture defined by a user based on the fused sensor data and the calibrated sensor data. In embodiments, the interaction 309 may be performed by the mapping module 157.

During an interaction 311, the mapping module may identify a computer command corresponding to the head gesture defined by the user. In embodiments, the interaction 311 may be performed by the mapping module 157.

During an interaction 313, a control module may perform a control based on the computer command. In embodiments, the interaction 313 may be performed by the control module 159. The control module 159 may perform a control based on the computer command identified by the mapping module 157.

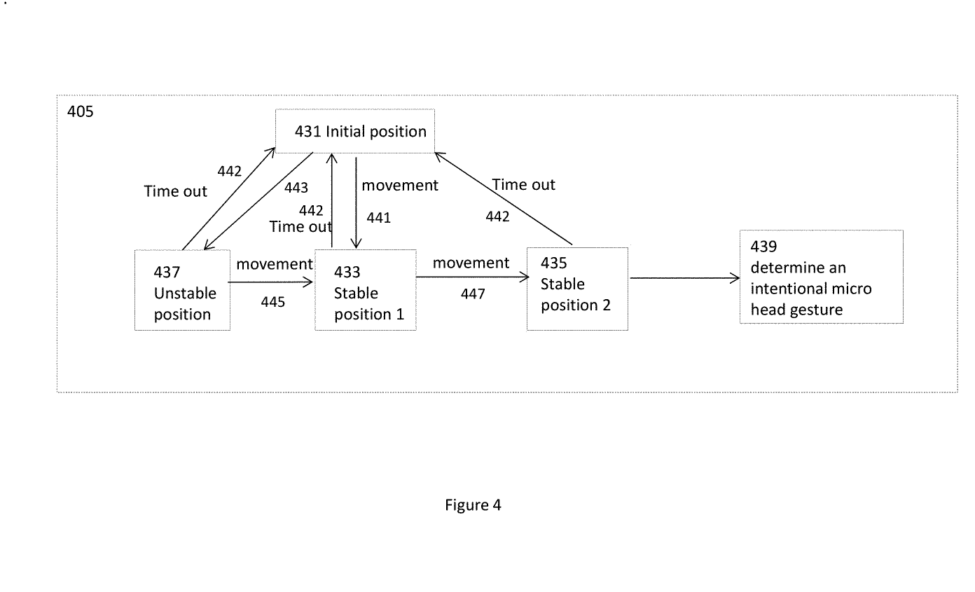

FIG. 4 illustrates an example process 405 for a computer device to determine a head gesture defined by a user, in accordance with various embodiments. In embodiments, the process 405 may be an example of the interaction 205 shown in FIG. 2, and may be a process performed by the mapping module 157 of the computer device 105 in FIG. 1, working together with other components such as the head worn wearable 103.

In embodiments, the mapping module 157 may determine that the user head may be at an initial position 431. Next, the mapping module 157 may determine that the user head may be at a first stable position 433, or at an unstable position 437, depending on the movement 441 or the movement 443 being detected by the head worn wearable 103.

If the user head may be at the first stable position 433, the mapping module 157 may determine that the user head may be at a second stable position 435 after the movement 447 being detected by the head worn wearable 103. Afterwards, at operation 439, the mapping module 157 may determine a head gesture defined by a user based on the first stable position 433 and the second stable position 435, where a head gesture defined by a user may be determined by comparing the first stable position 433 and the second stable position 435.

In addition, if the user head is at an unstable position 437, the mapping module 157 may determine that the user head may be at the first stable position 433 after the movement 445 being detected by the head worn wearable 103. Furthermore, the mapping module 157 may determine that the user head may be at the second stable position 435 after the movement 447 being detected by the head worn wearable 103. Afterwards, at operation 439, the mapping module 157 may determine a head gesture defined by a user based on the first stable position 433 and the second stable position 435.

In any of the unstable position 437, the first stable position 433, or the second stable position 435, the mapping module 157 may determine that a time out 442 has happened without any movement being detected by the head worn wearable 103. Once a time out 442 has been detected, the mapping module 157 may determine the user head is in the initial position 431.

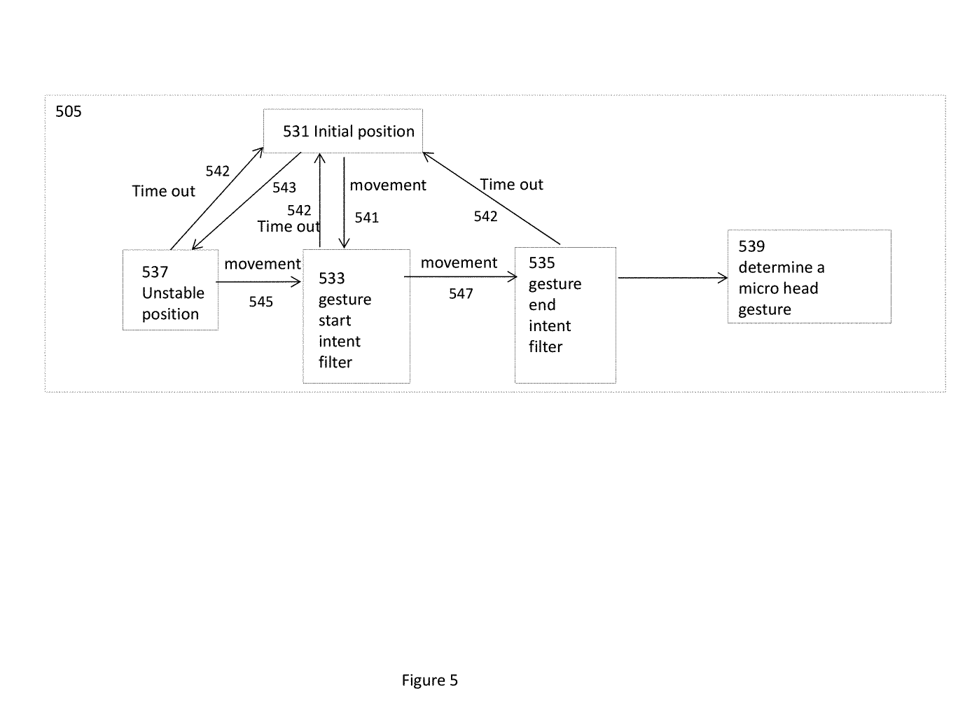

FIG. 5 illustrates another example process 505 for a computer device to determine a head gesture defined by a user, in accordance with various embodiments. In embodiments, the process 505 may be an example of the interaction 205 shown in FIG. 2, and may be a process performed by the mapping module 157 of the computer device 105 in FIG. 1, working together with other components such as the head worn wearable 103. Compared to the process 405, the processor 505 may be more general that can be applied to more broad situations. For example, instead of determining the user head is in a first stable position or a second stable position, the mapping module 157 may apply a gesture start intent filter or a gesture end intent filter, which may use any gesture intent filter algorithms.

In embodiments, the mapping module 157 may determine that the user head may be at an initial position 531. Next, the mapping module 157 may determine that the user head may be at a gesture start intent filter 533, or at an unstable position 537, depending on the movement 541 or the movement 543 being detected by the head worn wearable 103.

If the user head may be at the gesture start intent filter 533, the mapping module 157 may determine that the user head may be at a gesture end intent filter 535 after the movement 547 being detected by the head worn wearable 103. Afterwards, at operation 539, the mapping module 157 may determine a head gesture defined by a user based on the gesture start intent filter 533 and the gesture end intent filter 535, where a head gesture defined by a user may be determined by comparing the gesture start intent filter 533 and the gesture end intent filter 535.

In addition, if the user head is at an unstable position 537, the mapping module 157 may determine that the user head may be at the gesture start intent filter 533 after the movement 545 being detected by the head worn wearable 103. Furthermore, the mapping module 157 may determine that the user head may be at the gesture end intent filter 535 after the movement 547 being detected by the head worn wearable 103. Afterwards, at operation 539, the mapping module 157 may determine a head gesture defined by a user based on the gesture start intent filter 533 and the gesture end intent filter 535.

In any of the unstable position 537, the gesture start intent filter 533, or the gesture end intent filter 535, the mapping module 157 may determine that a time out 542 has happened without any movement being detected by the head worn wearable 103. Once a time out 542 has been detected, the mapping module 157 may determine the user head is in the initial position 531.

FIG. 6 illustrates exemplary head gestures defined by a user, in accordance with various embodiments. In embodiments, these head gestures defined by a user may be detected by the interaction 205 shown in FIG. 2, performed by the mapping module 157 of the computer device 105 in FIG. 1. In more details, these head gestures defined by a user may be detected by the process 405 shown in FIG. 4, or the process 505 shown in FIG. 5.

In embodiments, the user head may start at a neutral position 601, and may look down by a degree 603. Alternatively, the user head may start at a neutral position 601, and may look up by a degree 605. The movements of the head from the neutral position 601 by the degree 603 or the degree 605 may be detected by the head worn wearable 104, and the data generated by the head worn wearable 104 (after calibration) may be provided to the mapping module 157. When the degree 603 is less than a second predetermined degree, or the degree 605 is less than a first predetermined degree, the mapping module 157 may determine a head gesture defined by a user of look up, or a head gesture defined by a user of look down has been performed by the user. When the degree 605 is larger than the first predetermined degree, or the degree 603 is larger than the second predetermined degree, the mapping module 157 may determine that the movements of the user head do not fit a head gesture defined by a user, and may determine no head gesture defined by a user has been generated, despite the user head movements. In embodiments, the first predetermined degree, or the second predetermined degree may be less than 10 degree, 8 degree, or 15 degree, or any other degree that may be different (smaller) from the socially recognizable head movements.

In embodiments, the user head may start at a neutral position 611, and may look left by a degree 615. Alternatively, the user head may start at a neutral position 611, and may look right by a degree 613. The movements of the head from the neutral position 611 by the degree 613 or the degree 615 may be detected by the head worn wearable 103, and the data generated by the head worn wearable 104 (after calibration) may be provided to the mapping module 157. When the degree 615 is less than a fourth predetermined degree, or the degree 613 may be less than a third predetermined degree, the mapping module 157 may determine a head gesture defined by a user of look left, or a head gesture defined by a user of look right has been performed by the user. When the degree 615 is larger than the fourth predetermined degree, or the degree 613 may be larger than the third predetermined degree, the mapping module 157 may determine that the movements of the user head do not fit the head gesture defined by a user, and may determine no head gesture defined by a user has been generated, despite the user head movements. In embodiments, the third predetermined degree, or the fourth predetermined degree may be less than 10 degree, 8 degree, or 15 degree, or any other degree that may be different from the socially recognizable head movements.

In embodiments, the user head may start at a neutral position 621, and may tilt left by a degree 625. Alternatively, the user head may start at a neutral position 621, and may tilt right by a degree 623. The movements of the head from the neutral position 621 by the degree 623 or the degree 625 may be detected by the head worn wearable 104, and the data generated by the head worn wearable 104 (after calibration) may be provided to the mapping module 157. When the degree 625 is less than a sixth predetermined degree, or the degree 623 may be less than a fifth predetermined degree, the mapping module 157 may determine a head gesture defined by a user of tilt left, or a head gesture defined by a user of tilt right has been performed by the user. When the degree 625 is larger than the sixth predetermined degree, or the degree 623 may be larger than the fifth predetermined degree, the mapping module 157 may determine that the movements of the user head do not fit the predefined head gestures, and may determine no head gesture defined by a user has been generated, despite the user head movements. In embodiments, the fifth predetermined degree, or the sixth predetermined degree may be less than 10 degree, 8 degree, or 15 degree, or any other degree that may be different from the socially recognizable head movements.

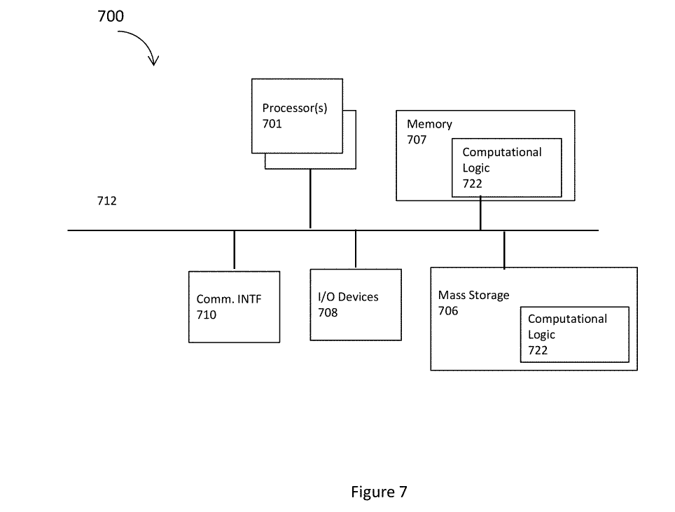

FIG. 7 illustrates an example computer device 700 that may be suitable as a device to practice selected aspects of the present disclosure. As shown, the device 700 may include one or more processors 701, each having one or more processor cores and optionally, a hardware accelerator 702 (which may be an ASIC or a FPGA). The device 700 may be an example of the computer device 105 as shown in FIG. 1, and the one or more processors 701 may be an example of the processor 150 as shown in FIG. 1. In addition, the device 700 may include a memory 707, which may be any one of a number of known persistent storage medium; a mass storage 706, and one or more input/output devices 708. Furthermore, the device 700 may include a communication interface 710. The communication interface 710 may be any one of a number of known communication interfaces, which may be an example of the receiver 151 of the computer device 105. The elements may be coupled to each other via system bus 712, which may represent one or more buses. In the case of multiple buses, they may be bridged by one or more bus bridges (not shown).

Each of these elements may perform its conventional functions known in the art. In particular, the system memory 707 may be employed to store a working copy and a permanent copy of the programming instructions implementing in software in whole or in part the operations associated with a computer device to perform a control based on a subtle head gesture defined by a user, as described in connection with FIGS. 1-6, and/or other functions, collectively referred to as computational logic 722 that provides the capability of the embodiments described in the current disclosure. The various elements may be implemented by assembler instructions supported by processor(s) 701 or high-level languages, such as, for example, C, that can be compiled into such instructions. Operations associated with a computer device to perform a control based on a subtle head gesture defined by a user not implemented in software may be implemented in hardware, e.g., via hardware accelerator 702.

The number, capability and/or capacity of these elements 701-722 may vary, depending on the number of other devices the device 700 is configured to support. Otherwise, the constitutions of elements 701-722 are known, and accordingly will not be further described.

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module,” or “system.”

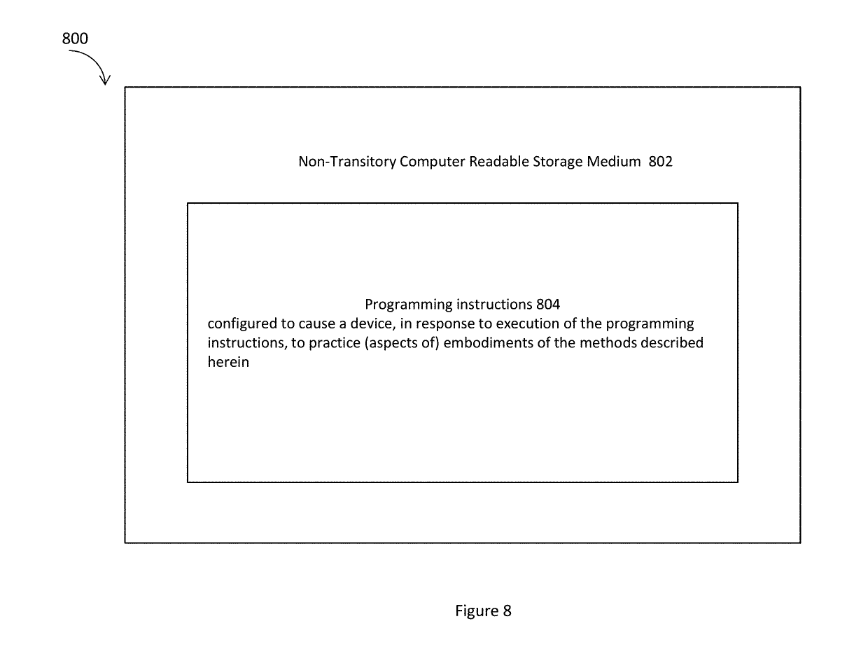

Furthermore, the present disclosure may take the form of a computer program product embodied in any tangible or non-transitory medium of expression having computer-usable program code embodied in the medium. FIG. 8 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 802 may include a number of programming instructions 804. Programming instructions 804 may be configured to enable a device, e.g., device 700, in response to execution of the programming instructions, to perform, e.g., various operations associated with the processor 150 as shown in FIG. 1, where the operations may include those described in the process 200 as shown in FIG. 2, the flow diagram 300 as shown in FIG. 3, the process 405 as shown in FIG. 4, or the processor 505 as shown in FIG. 5.

In alternate embodiments, programming instructions 804 may be disposed on multiple computer-readable non-transitory storage media 802 instead. In alternate embodiments, programming instructions 804 may be disposed on computer-readable transitory storage media 802, such as, signals. Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Embodiments may be implemented as a computer process, a computing system or as an article of manufacture such as a computer program product of computer readable media. The computer program product may be a computer storage medium readable by a computer system and encoding a computer program instructions for executing a computer process.

The corresponding structures, material, acts, and equivalents of all means or steps plus function elements in the claims below are intended to include any structure, material or act for performing the function in combination with other claimed elements are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment are chosen and described in order to best explain the principles of the disclosure and the practical application, and to enable others of ordinary skill in the art to understand the disclosure for embodiments with various modifications as are suited to the particular use contemplated.

Thus various example embodiments of the present disclosure have been described including, but are not limited to:

Example 1 may include a computer device for use with a head worn wearable, comprising: a receiver to receive sensor data output by a plurality of sensors of the head worn wearable while the head worn wearable is adorn on a head of a user; and a calibrator coupled to the receiver to calibrate the sensor data of the plurality of sensors of the head worn wearable for one or more notifications or events to generate calibrated sensor data that reflects physical attributes, positions or postures of the user; wherein the calibrated sensor data are used to determine an orientation or movement of the head of the user, which are used to detect a head gesture defined by the user that corresponds to a computer command.

Example 2 may include the computer device of example 1 and/or some other examples herein, further comprising: a mapping module coupled to the calibrator and the receiver, wherein the mapping module is to: determine the head gesture defined by the user based on the calibrated sensor data; and identify the computer command corresponding to the head gesture defined by the user.

Example 3 may include the computer device of example 2 and/or some other examples herein, further comprising: a control module coupled to the mapping module to perform a control based on the computer command.

Example 4 may include the computer device of example 2 and/or some other examples herein, wherein to determine the head gesture defined by the user, the mapping module is to: detect the head of the user in an initial position; detect the head of the user in a gesture start position; detect the head of the user in a gesture end position; and determine the head gesture defined by the user based on the initial position, the gesture start position, and the gesture end position.

Example 5 may include the computer device of example 2 and/or some other examples herein, wherein the mapping module is further to: wait for a delay period after the mapping module has determined the head gesture defined by the user, and before the mapping module is to identify the computer command corresponding to the head gesture defined by the user.

Example 6 may include the computer device of example 2 and/or some other examples herein, wherein the plurality of sensors are of different sensor types, the received sensor data are of different types of sensor data; and the computer device further comprises: a sensor fusion module coupled to the calibrator, the receiver, and the mapping module, wherein the sensor fusion module is to apply a sensor data fusion algorithm to the received sensor data of different types to generate fused sensor data, the calibrator is to generate the calibrated sensor data based on the fused sensor data; and the mapping module is to determine the head gesture defined by the user based on the fused sensor data.

Example 7 may include the computer device of example 3 and/or some other examples herein, further comprising: a display device coupled to the computer device, wherein the computer command is related to an object displayed on the display device, and the control module of the computer device is to perform the control on a data object that corresponds to the displayed object based on the computer command.

Example 8 may include the computer device of example 7 and/or some other examples herein, wherein the object displayed on the display device includes a button, a slider, a scroll wheel, a window, an icon, a menu, a pointer, a widget, a shortcut, a notification, a label, a folder, or a toolbar.

Example 9 may include the computer device of example 7 and/or some other examples herein, wherein the computer command is a command to interact with the object displayed on the display device, a command to expand the object displayed, a command to close the object displayed, a command to select the object displayed, or a command to steady move from a first part of the object displayed to a second part of the object displayed.

Example 10 may include the computer device of any one of examples 1-2 and/or some other examples herein, wherein the computer command is a command to lock the computer device, a command to unlock the computer device, a command to shut off the computer device, a command to accept an incoming call, or a system command.

Example 11 may include the computer device of any one of examples 1-2 and/or some other examples herein, wherein the head worn wearable comprises an inertial measurement unit (IMU), the IMU includes an accelerometer, a gyroscope, or a magnetometer, and the sensor data includes roll rotation data for the user's head, pitch rotation data for the user's head, or yaw rotation data for the user's head.

Example 12 may include the computer device of any one of examples 1-2 and/or some other examples herein, wherein the head gesture defined by the user includes a gesture of look up by a degree less than a first predetermined degree, a gesture of look down by a degree less than a second predetermined degree, a gesture of look right by a degree less than a third predetermined degree, a gesture of look left by a degree less than a fourth predetermined degree, a gesture of tilt right by a degree less than a fifth predetermined degree, a gesture of tilt left by a degree less than a sixth predetermined degree, or a gesture of steady movement of the user's head.

Example 13 may include the computer device of example 12 and/or some other examples herein, wherein the first predetermined degree, the second predetermined degree, the third predetermined degree, the fourth predetermined degree, the fifth predetermined degree, or the sixth predetermined degree is less than 10 degree.

Example 14 may include the computer device of any one of examples 1-2 and/or some other examples herein, wherein the user is in a standing position, a sitting position, or a lying position.

Example 15 may include the computer device of any one of examples 1-2 and/or some other examples herein, wherein the one or more notifications or events includes a change from a first position to a second position by the user, wherein the first position is a position selected from a standing position, a sitting position, or a lying position, the second position is different from the first position and is a position selected from a standing position, a sitting position, or a lying position.

Example 16 may include the computer device of any one of examples 1-2 and/or some other examples herein, wherein the computer device is integrated with the head worn wearable.

Example 17 may include the computer device of any one of examples 1-2 and/or some other examples herein, further comprises a processor to operate the calibrator.

Example 18 may include a method for control a computer device with a head worn wearable, comprising: receiving sensor data output by a plurality of sensors of the head worn wearable while the head worn wearable is adorn on a head of a user; calibrating the sensor data of the plurality of sensors of the head worn wearable for one or more notifications or events to generate calibrated sensor data that reflects physical attributes, positions or postures of the user; determining a head gesture defined by the user based on the calibrated sensor data; identifying a computer command corresponding to the head gesture defined by the user; and performing a control based on the computer command.

Example 19 may include the method of example 18 and/or some other examples herein, wherein the determining the head gesture defined by the user includes: detecting the head of the user in an initial position; detecting the head of the user in a gesture start position; detecting the head of the user in a gesture end position; and determining the head gesture defined by the user based on the initial position, the gesture start position, and the gesture end position.

Example 20 may include the method of example 18 and/or some other examples herein, wherein the plurality of sensors are of different sensor types, the received sensor data are of different types of sensor data, and the method further comprises: applying a sensor data fusion algorithm to the sensor data of different types to generate fused sensor data; calibrating the fused sensor data to generate calibrated sensor data; and determining the head gesture defined by the user based on the fused sensor data.

Example 21 may include the method of any one of examples 18-20 and/or some other examples herein, wherein the computer command is a command to lock the computer device, a command to unlock the computer device, a command to shut off the computer device, a command to accept an incoming call, or a system command.

Example 22 may include the method of any one of examples 18-20 and/or some other examples herein, wherein the head gesture defined by the user includes a gesture of look up by a degree less than a first predetermined degree, a gesture of look down by a degree less than a second predetermined degree, a gesture of look right by a degree less than a third predetermined degree, a gesture of look left by a degree less than a fourth predetermined degree, a gesture of tilt right by a degree less than a fifth predetermined degree, a gesture of tilt left by a degree less than a sixth predetermined degree, or a gesture of steady movement of the user head, and the first predetermined degree, the second predetermined degree, the third predetermined degree, the fourth predetermined degree, the fifth predetermined degree, or the sixth predetermined degree is less than 10 degree.

Example 23 may include one or more non-transitory computer-readable media comprising instructions that cause a computer device, in response to execution of the instructions by the computer device, to operate the computer device to: receive sensor data output by a plurality of sensors of a head worn wearable while the head worn wearable is adorn on a head of a user; calibrate the sensor data of the plurality of sensors of the head worn wearable for one or more notifications or events to generate calibrated sensor data that reflects physical attributes, positions or postures of the user; determine a head gesture defined by the user based on the calibrated sensor data; identify a computer command corresponding to the head gesture defined by the user; and perform a control based on the computer command.

Example 24 may include the one or more non-transitory computer-readable media of example 23 and/or some other examples herein, wherein the head gesture defined by the user includes a gesture of look up by a degree less than a first predetermined degree, a gesture of look down by a degree less than a second predetermined degree, a gesture of look right by a degree less than a third predetermined degree, a gesture of look left by a degree less than a fourth predetermined degree, a gesture of tilt right by a degree less than a fifth predetermined degree, a gesture of tilt left by a degree less than a sixth predetermined degree, or a gesture of steady movement of the user head, and the first predetermined degree, the second predetermined degree, the third predetermined degree, the fourth predetermined degree, the fifth predetermined degree, or the sixth predetermined degree is less than 10 degree.

Example 25 may include the one or more non-transitory computer-readable media of any one of examples 23-24 and/or some other examples herein, wherein the head worn wearable comprises an inertial measurement unit (IMU), the IMU includes an accelerometer, a gyroscope, or a magnetometer, and the sensor data includes roll rotation data for the user's head, pitch rotation data for the user's head, or yaw rotation data for the user's head.

Example 26 may include one or more computer-readable media having instructions for a computer device to handle errors, upon execution of the instructions by one or more processors, to perform the method of any one of claims 18-22.

Example 27 may include an apparatus for control a computer device with a head worn wearable, comprising: means for receiving sensor data output by a plurality of sensors of the head worn wearable while the head worn wearable is adorn on a head of a user; means for calibrating the sensor data of the plurality of sensors of the head worn wearable for one or more notifications or events to generate calibrated sensor data that reflects physical attributes, positions or postures of the user; means for determining a head gesture defined by the user based on the calibrated sensor data; means for identifying a computer command corresponding to the head gesture defined by the user; and means for performing a control based on the computer command.

Example 28 may include the apparatus of example 27 and/or some other examples herein, wherein the means for determining the head gesture defined by the user includes: means for detecting the head of the user in an initial position; means for detecting the head of the user in a gesture start position; means for detecting the head of the user in a gesture end position; and means for determining the head gesture defined by the user based on the initial position, the gesture start position, and the gesture end position.

Example 29 may include the apparatus of example 27 and/or some other examples herein, wherein the plurality of sensors are of different sensor types, the received sensor data are of different types of sensor data, and the apparatus further comprises: means for applying a sensor data fusion algorithm to the sensor data of different types to generate fused sensor data; means for calibrating the fused sensor data to generate calibrated sensor data; and means for determining the head gesture defined by the user based on the fused sensor data.

Example 30 may include the apparatus of any one of examples 27-29 and/or some other examples herein, wherein the computer command is a command to lock the computer device, a command to unlock the computer device, a command to shut off the computer device, a command to accept an incoming call, or a system command.

Example 31 may include the apparatus of any one of examples 27-29 and/or some other examples herein, wherein the head gesture defined by the user includes a gesture of look up by a degree less than a first predetermined degree, a gesture of look down by a degree less than a second predetermined degree, a gesture of look right by a degree less than a third predetermined degree, a gesture of look left by a degree less than a fourth predetermined degree, a gesture of tilt right by a degree less than a fifth predetermined degree, a gesture of tilt left by a degree less than a sixth predetermined degree, or a gesture of steady movement of the user head, and the first predetermined degree, the second predetermined degree, the third predetermined degree, the fourth predetermined degree, the fifth predetermined degree, or the sixth predetermined degree is less than 10 degree.

Example 32 may include the apparatus of any one of examples 27-29 and/or some other examples herein, wherein the user is in a standing position, a sitting position, or a lying position.

Example 33 may include the apparatus of any one of examples 27-29 and/or some other examples herein, wherein the one or more notifications or events includes a change from a first position to a second position by the user, wherein the first position is a position selected from a standing position, a sitting position, or a lying position, the second position is different from the first position and is a position selected from a standing position, a sitting position, or a lying position.

Example 34 may include the apparatus of any one of examples 27-29 and/or some other examples herein, wherein the computer device is integrated with the head worn wearable.

Although certain embodiments have been illustrated and described herein for purposes of description this application is intended to cover any adaptations or variations of the embodiments discussed herein. Therefore, it is manifestly intended that embodiments described herein be limited only by the claims.

hat is claimed is:

1. A computer device for use with a head worn wearable, comprising:
a receiver to receive sensor data output by a plurality of sensors of the head worn wearable while the head worn wearable is adorn on a head of a user; and
a calibrator coupled to the receiver to calibrate the sensor data of the plurality of sensors of the head worn wearable for one or more notifications or events to generate calibrated sensor data that reflects physical attributes, positions or postures of the user;
wherein the calibrated sensor data are used to determine an orientation or movement of the head of the user, which are used to detect a head gesture defined by the user that corresponds to a computer command.

2. The computer device of claim 1, further comprising:
a mapping module coupled to the calibrator and the receiver, wherein the mapping module is to:
determine the head gesture defined by the user based on the calibrated sensor data; and
identify the computer command corresponding to the head gesture defined by the user.

3. The computer device of claim 2, further comprising:
a control module coupled to the mapping module to perform a control based on the computer command.

4. The computer device of claim 2, wherein to determine the head gesture defined by the user, the mapping module is to:
detect the head of the user in an initial position;
detect the head of the user in a gesture start position;
detect the head of the user in a gesture end position; and
determine the head gesture defined by the user based on the initial position, the gesture start position, and the gesture end position.

5. The computer device of claim 2, wherein the mapping module is further to:
wait for a delay period after the mapping module has determined the head gesture defined by the user, and before the mapping module is to identify the computer command corresponding to the head gesture defined by the user.

6. The computer device of claim 2, wherein the plurality of sensors are of different sensor types, the received sensor data are of different types of sensor data; and the computer device further comprises:
a sensor fusion module coupled to the calibrator, the receiver, and the mapping module, wherein the sensor fusion module is to apply a sensor data fusion algorithm to the received sensor data of different types to generate fused sensor data, the calibrator is to generate the calibrated sensor data based on the fused sensor data; and
the mapping module is to determine the head gesture defined by the user based on the fused sensor data.

7. The computer device of claim 3, further comprising:
a display device coupled to the computer device, wherein the computer command is related to an object displayed on the display device, and the control module of the computer device is to perform the control on a data object that corresponds to the displayed object based on the computer command.

8. The computer device of claim 7, wherein the object displayed on the display device includes a button, a slider, a scroll wheel, a window, an icon, a menu, a pointer, a widget, a shortcut, a notification, a label, a folder, or a toolbar.

9. The computer device of claim 7, wherein the computer command is a command to interact with the object displayed on the display device, a command to expand the object displayed, a command to close the object displayed, a command to select the object displayed, or a command to steady move from a first part of the object displayed to a second part of the object displayed.

10. The computer device of claim 1, wherein the computer command is a command to lock the computer device, a command to unlock the computer device, a command to shut off the computer device, a command to accept an incoming call, or a system command.

11. The computer device of claim 1, wherein the head worn wearable comprises an inertial measurement unit (IMU), the IMU includes an accelerometer, a gyroscope, or a magnetometer, and the sensor data includes roll rotation data for the user's head, pitch rotation data for the user's head, or yaw rotation data for the user's head.

12. The computer device of claim 1, wherein the head gesture defined by the user includes a gesture of look up by a degree less than a first predetermined degree, a gesture of look down by a degree less than a second predetermined degree, a gesture of look right by a degree less than a third predetermined degree, a gesture of look left by a degree less than a fourth predetermined degree, a gesture of tilt right by a degree less than a fifth predetermined degree, a gesture of tilt left by a degree less than a sixth predetermined degree, or a gesture of steady movement of the user's head.

13. The computer device of claim 12, wherein the first predetermined degree, the second predetermined degree, the third predetermined degree, the fourth predetermined degree, the fifth predetermined degree, or the sixth predetermined degree is less than 10 degree.

14. The computer device of claim 1, wherein the user is in a standing position, a sitting position, or a lying position.

15. The computer device of claim 1, wherein the one or more notifications or events includes a change from a first position to a second position by the user, wherein the first position is a position selected from a standing position, a sitting position, or a lying position, the second position is different from the first position and is a position selected from a standing position, a sitting position, or a lying position.

16. The computer device of claim 1, wherein the computer device is integrated with the head worn wearable.

17. The computer device of claim 1, further comprises a processor to operate the calibrator.

18. A method for control a computer device with a head worn wearable, comprising:
receiving sensor data output by a plurality of sensors of the head worn wearable while the head worn wearable is adorn on a head of a user;
calibrating the sensor data of the plurality of sensors of the head worn wearable for one or more notifications or events to generate calibrated sensor data that reflects physical attributes, positions or postures of the user;
determining a head gesture defined by the user based on the calibrated sensor data;
identifying a computer command corresponding to the head gesture defined by the user; and
performing a control based on the computer command.

19. The method of claim 18, wherein the determining the head gesture defined by the user includes:
detecting the head of the user in an initial position;
detecting the head of the user in a gesture start position;
detecting the head of the user in a gesture end position; and
determining the head gesture defined by the user based on the initial position, the gesture start position, and the gesture end position.

20. The method of claim 18, wherein the plurality of sensors are of different sensor types, the received sensor data are of different types of sensor data, and the method further comprises:
applying a sensor data fusion algorithm to the sensor data of different types to generate fused sensor data;
calibrating the fused sensor data to generate calibrated sensor data; and
determining the head gesture defined by the user based on the fused sensor data.

21. The method of claim 18, wherein the computer command is a command to lock the computer device, a command to unlock the computer device, a command to shut off the computer device, a command to accept an incoming call, or a system command.

22. The method of claim 18, wherein the head gesture defined by the user includes a gesture of look up by a degree less than a first predetermined degree, a gesture of look down by a degree less than a second predetermined degree, a gesture of look right by a degree less than a third predetermined degree, a gesture of look left by a degree less than a fourth predetermined degree, a gesture of tilt right by a degree less than a fifth predetermined degree, a gesture of tilt left by a degree less than a sixth predetermined degree, or a gesture of steady movement of the user head, and the first predetermined degree, the second predetermined degree, the third predetermined degree, the fourth predetermined degree, the fifth predetermined degree, or the sixth predetermined degree is less than 10 degree.

23. One or more non-transitory computer-readable media comprising instructions that cause a computer device, in response to execution of the instructions by the computer device, to operate the computer device to:
receive sensor data output by a plurality of sensors of a head worn wearable while the head worn wearable is adorn on a head of a user;
calibrate the sensor data of the plurality of sensors of the head worn wearable for one or more notifications or events to generate calibrated sensor data that reflects physical attributes, positions or postures of the user;
determine a head gesture defined by the user based on the calibrated sensor data;
identify a computer command corresponding to the head gesture defined by the user; and
perform a control based on the computer command.

24. The one or more non-transitory computer-readable media of claim 23, wherein the head gesture defined by the user includes a gesture of look up by a degree less than a first predetermined degree, a gesture of look down by a degree less than a second predetermined degree, a gesture of look right by a degree less than a third predetermined degree, a gesture of look left by a degree less than a fourth predetermined degree, a gesture of tilt right by a degree less than a fifth predetermined degree, a gesture of tilt left by a degree less than a sixth predetermined degree, or a gesture of steady movement of the user head, and the first predetermined degree, the second predetermined degree, the third predetermined degree, the fourth predetermined degree, the fifth predetermined degree, or the sixth predetermined degree is less than 10 degree.

25. The one or more non-transitory computer-readable media of claim 23, wherein the head worn wearable comprises an inertial measurement unit (IMU), the IMU includes an accelerometer, a gyroscope, or a magnetometer, and the sensor data includes roll rotation data for the user's head, pitch rotation data for the user's head, or yaw rotation data for the user's head.
